(19) United States
(12) Patent Application Publication
(10) Pub. No.: US 2026/0074119 A1
(43) Pub. Date: Mar. 12, 2026

(54) MULTILAYER CERAMIC CAPACITOR

(71) Applicant: SAMSUNG ELECTRO-MECHANICS CO., LTD., Suwon-si (KR)

(72) Inventors: Euihyun Jo, Suwon-si (KR); Jin Sung Kim, Suwon-si (KR); IIhee Kim, Suwon-si (KR); Byungkun Kim, Suwon-si, Gyeonggi-do (KR); Mingon Lee, Suwon-si (KR)

(73) Assignee: SAMSUNG ELECTRO-MECHANICS CO., LTD., Suwon-si (KR)

(21) Appl. No.: 19/092,618

(22) Filed: Mar. 27, 2025

(30) Foreign Application Priority Data
Sep. 11, 2024 (KR) 10-2024-0123853

(51) Int. Cl. H01G 4/232; H01G 4/30

(52) U.S. Cl. CPC H01G 4/2325; H01G 4/30

(57) ABSTRACT

A disclosed multilayer ceramic capacitor includes a ceramic body configured to include a plurality of dielectric layers and internal electrodes arranged with the dielectric layers provided therebetween; and external electrodes arranged at opposite sides of the ceramic body in a first direction, respectively. The external electrodes include, respectively: a first glass portion positioned on a first end surface of the ceramic body and connected to the internal electrodes; and a second glass portion positioned on at least a portion of at least one of second and third directional side surfaces of the ceramic body and containing an iron (Fe) component.

### CROSS-REFERENCE TO RELATED APPLICATION

This application claims priority to and the benefit of Korean Patent Application No. 10-2024-0123853, filed in the Korean Intellectual Property Office on Sep. 11, 2024, the entire contents of which are incorporated herein by reference.

### BACKGROUND

### (a) Field

The present disclosure relates to a multilayer ceramic capacitor.

### (b) Description of the Related Art

Electronic components using ceramic materials include capacitors, inductors, piezoelectric elements, varistors, or thermistors. Among such ceramic electronic components, a multilayer ceramic capacitor (MLCC) may be used in various electronic devices due to its small size, high capacity, and easy mounting.

The multilayer capacitor may be electronic components in a form of chips that are mounted in boards of various electronic products to charge or discharge electricity, including imaging such as liquid crystal displays (LCD), on the display panel, plasma display panels (PDP), and organic light-emitting diode (OLED) displays, computers, personal portable terminals, and smartphones.

As usage environments of multilayer ceramic capacitors become more diverse, moisture resistance reliability of multilayer ceramic capacitors is considered important.

The multilayer ceramic capacitor may include an internal electrode disposed inside a ceramic body and an external electrode disposed outside the ceramic body and connected to an internal electrode. In order to increase effective capacity for miniaturizing and increasing capacitance of the multilayer ceramic capacitors, methods may be sought to increase a size of the ceramic body and make a thickness of the external electrodes as thin as possible.

However, as the thickness of the external electrode is reduced to increase the size of the ceramic body, hermetic sealing of the external electrode deteriorates, which may cause a problem in that the moisture resistance reliability of the multilayer ceramic capacitor deteriorates.

### SUMMARY

One aspect of the embodiment attempts to provide a multilayer ceramic capacitor capable of ensuring hermetic sealing while reducing a thickness of an external electrode.

However, the problem to be solved by the embodiments of the present disclosure is not limited to the above-described problems, and can be variously extended within the scope of the technical spirit included in the present disclosure.

An embodiment of the present disclosure provides a multilayer ceramic capacitor including: a ceramic body including a plurality of dielectric layers and internal electrodes arranged with the dielectric layers provided therebetween; and external electrodes arranged at opposite sides of the ceramic body in a first direction, respectively. The external electrodes include, respectively: a first glass portion positioned on a first end surface of the ceramic body and connected to the internal electrodes; and a second glass portion positioned on at least a portion of at least one of second and third directional side surfaces of the ceramic body and containing an iron (Fe) component.

The second glass portion may contain 5 to 10 wt % of iron (Fe) component.

For the external electrodes, T2/T1 may be within 0.4 and 1, in which T1 is a thickness of a central portion of the first directional end surface of the ceramic body in the first direction and T2 is a thickness of the external electrodes disposed at an edge between the first directional end surface and the at least one of second and third directional side surfaces of the ceramic body.

Herein, the T2/T1 may be 0.4 to 0.6.

The first glass portion may include a metal including copper (Cu) or nickel (Ni) and Ba-based or Zn-based glass.

The second glass portion may include a metal including copper (Cu) or nickel (Ni) and Ba-based or Zn-based glass.

The external electrodes may further include a plating layer covering the first glass portion and the second glass portion.

An embodiment of the present disclosure provides a multilayer ceramic capacitor including: a ceramic body including a plurality of dielectric layers and internal electrodes arranged with the dielectric layers provided therebetween; and external electrodes arranged at opposite sides of the ceramic body in a first direction, respectively. The external electrodes include a metal component and a glass component, and a portion of the external electrodes, positioned on at least one of second and third directional side surfaces of the ceramic body, further contain an iron (Fe) component.

The external electrodes may contain 5 to 10 wt % of iron (Fe) component. For the external electrodes, T2/T1 may be within 0.4 and 1, in which T1 is a thickness of a central portion of the first directional end surface of the ceramic body in the first direction and T2 is a thickness of the external electrodes disposed at an edge between the first directional end surface and the at least one of second and third directional side surfaces of the ceramic body.

Herein, the T2/T1 may be 0.4 to 0.6.

The metal component may include copper (Cu) or nickel (Ni).

The glass component may include Ba-based or Zn-based glass.

An embodiment of the present disclosure provides a multilayer ceramic capacitor including: a ceramic body including a plurality of dielectric layers and first and second internal electrodes arranged with the dielectric layers provided therebetween; and first and second external electrodes arranged at opposite sides of the ceramic body in a first direction, respectively. The first external electrode includes: a first glass portion positioned on a first directional end surface of the ceramic body and connected to the first internal electrodes; and a second glass portion positioned on at least a portion of at least one of second and third directional side surfaces of the ceramic body and having a content of iron (Fe) greater than a content of Iron (Fe) in the first glass portion.

A content of Iron (Fe) in the first external electrode may decrease in an edge between the first directional end surface and the at least one of second and third directional side surfaces of the ceramic body, along a path from the second glass portion to the first glass portion.

In accordance with a multilayer ceramic capacitor according to an embodiment, an effective capacity of the multilayer ceramic capacitor may be increased by reducing the thickness of the external electrode, and a moisture-resistant reliability of the multilayer ceramic capacitor may be improved by ensuring hermetic sealing of the external electrode.

However, it is obvious that the effect of the embodiments is not limited to the above-described effect, and may be variously extended without departing from the spirit and scope of the embodiments.

### BRIEF DESCRIPTION OF THE DRAWINGS

FIG. 1 illustrates a schematic perspective view showing a multilayer ceramic capacitor according to an embodiment.

FIG. 2 illustrates a cross-sectional view taken along a line II-II′ of FIG. 1.

FIG. 3 illustrates an enlarged view of a region A of FIG. 2.

FIG. 4 illustrates a perspective view showing a stacked structure of internal electrodes in the multilayer ceramic capacitor of FIG. 1.

FIG. 5 illustrates a digital image showing a portion of a multilayer ceramic capacitor according to an embodiment.

FIG. 6 illustrates a digital image showing a portion of a multilayer ceramic capacitor according to an embodiment.

FIG. 7 illustrates a digital image showing a portion of a multilayer ceramic capacitor according to a comparative embodiment.

FIG. 8 illustrates a digital image showing a portion of a multilayer ceramic capacitor according to a comparative embodiment.

### DETAILED DESCRIPTION

Hereinafter, various embodiment of the present disclosure will be described in detail so that a person of ordinary skill in the technical field to which the present disclosure belongs can easily implement it with reference to the accompanying drawings. The drawings and description are to be regarded as illustrative in nature and not restrictive. Like reference numerals designate like elements throughout the specification. In addition, some components in the accompanying drawings are exaggerated, omitted, or schematically illustrated, and the size of each component does not fully reflect the actual size.

The accompanying drawings are provided only in order to allow embodiments disclosed in the present specification to be easily understood and are not to be interpreted as limiting the spirit disclosed in the present specification, and it is to be understood that the present invention includes all modifications, equivalents, and substitutions without departing from the scope and spirit of the present invention.

Terms including ordinal numbers such as first, second, and the like will be used only to describe various components, and are not to be interpreted as limiting these components. The terms are only used to differentiate one component from other components.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

It will be further understood that terms “comprises/includes” or “have” used throughout the specification specify the presence of stated features, numerals, steps, operations, components, parts, or a combination thereof, but do not preclude the presence or addition of one or more other features, numerals, steps, operations, components, parts, or a combination thereof. Accordingly, unless explicitly described to the contrary, the word “comprise” and variations such as “comprises” or “comprising” will be understood to imply the inclusion of stated components but not the exclusion of any other components.

Further, throughout the specification, the phrase “in a plan view” means when an object portion is viewed from above, and the phrase “in a cross-sectional view” means when a cross-section taken by vertically cutting an object portion is viewed from the side.

In addition, throughout the specification, “connected” means that two or more components are not only directly connected, but two or more components may be connected indirectly through other components, physically connected as well as being electrically connected, or it may be referred to by different names depending on the location or function, but may mean integral.

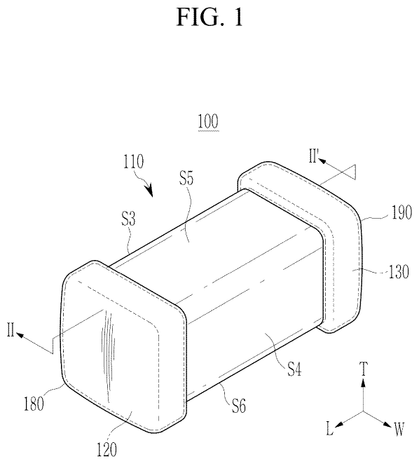

FIG. 1 illustrates a schematic perspective view showing a multi-layered ceramic capacitor according to an embodiment,

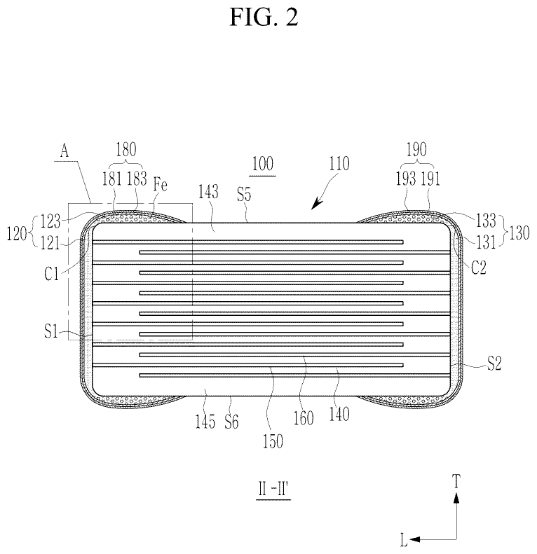

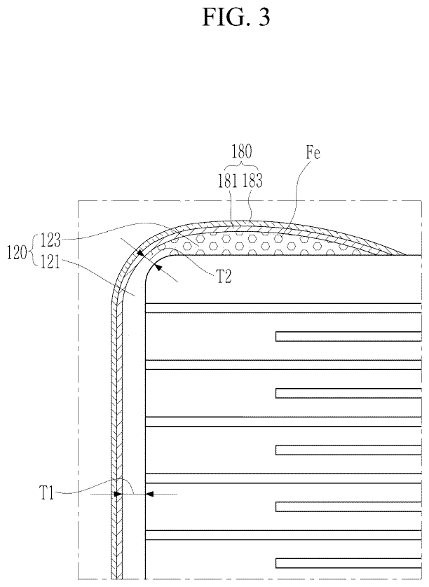

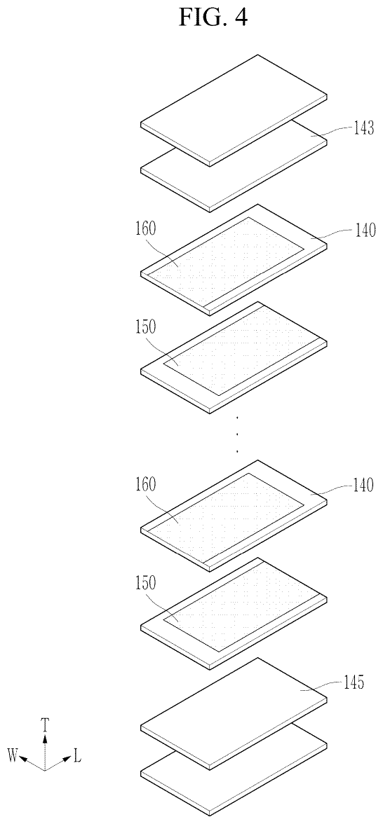

FIG. 2 illustrates a cross-sectional view taken along a line II-II′ of FIG. 1, FIG. 3 illustrates an enlarged view of a region A of FIG. 2, FIG. 4 illustrates a perspective view showing a stacked structure of an internal electrode in the multilayer ceramic capacitor of FIG. 1,

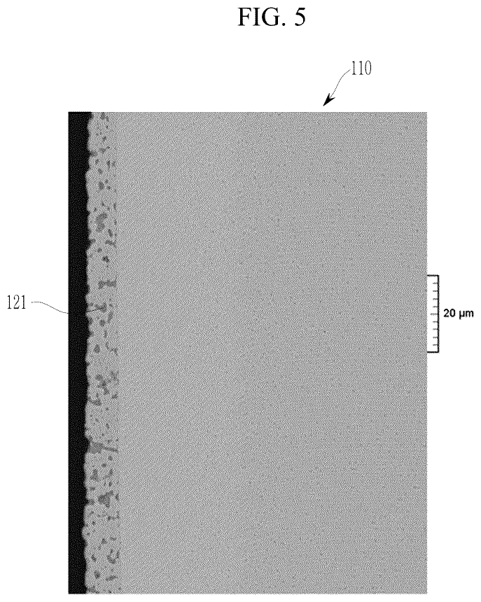

FIG. 5 illustrates a schematic perspective view showing a multi-layered ceramic capacitor according to an embodiment, and

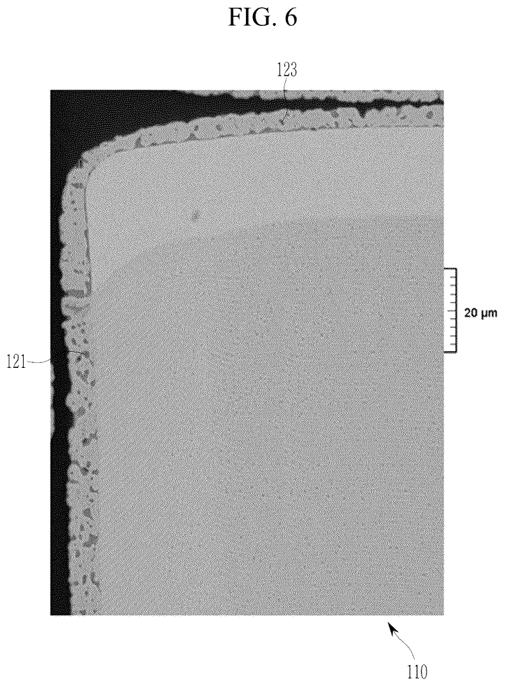

FIG. 6 illustrates a digital image showing a portion of a multilayer ceramic capacitor according to an embodiment.

Referring to FIG. 1 to FIG. 6, the multilayer ceramic capacitor 100 according to the present embodiment may include a ceramic body 110, a first external electrode 120, a second external electrode 130, a plurality of first internal electrodes 150, and a plurality of second internal electrodes 160.

First, when directions are defined to clearly describe the present embodiment, L-axis, W-axis, T-axis indicated in the figures indicate axes representing a length direction, a width direction, and a thickness direction of the multilayer ceramic capacitor 100, respectively.

The thickness direction (T-axis direction) may be a direction that is perpendicular to wide surfaces (main surfaces) of components each having a sheet shape. For example, the thickness direction (T-axis direction) may be used as the same concept as a direction in which a dielectric layer 140 is stacked.

The length direction (L-axis direction), which is the direction parallel to the wide surfaces (main surfaces) of the sheet-like components, may be a direction that intersects (or is orthogonal to) the thickness direction (T-axis direction). For example, the length direction (L-axis direction) may be a direction in which the first external electrode 120 and the second external electrode 130 face each other.

The width direction (W-axis direction), which is a direction parallel to the wide surface (main surface) of the sheet-like components, may simultaneously intersect (or orthogonal to) the thickness direction (T-axis direction) and the length direction (L-axis direction).

The ceramic body 110 may be formed to have a substantially hexahedral shape, but the present embodiment is not limited thereto. Due to shrinkage during sintering, the ceramic body 110 may have the substantially hexahedral shape, but not a perfect hexahedral shape. For example, the ceramic body 110 has a substantially rectangular parallelepiped shape, but portions corresponding to corners or vertices may each have a round shape.

In the present embodiment, for better understanding and ease of description, surfaces facing each other in the longitudinal direction (L-axis direction) are defined as a longitudinally-directional end surface or a first surface S1 and a second surface S2, surfaces facing each other in the width direction (W-axis direction) and connecting the first surface S1 and the second surface S2 are defined as a width-directional side surface or a third surface S3 and a fourth surface S4, and surfaces facing each other in the thickness direction (T-axis direction) and connecting the first surface S1 and the second surface S2 are defined as a thickness-directional side surface or a fifth surface S5 and a sixth surface S6.

Accordingly, a first direction in which the first surface S1 and the second surface S2 face each other may be the longitudinal direction (L-axis direction), and second and third directions perpendicular to the first direction and perpendicular to each other may be the thickness direction (T-axis direction) and the width direction (W-axis direction) or the width direction (W-axis direction) and the thickness direction (T-axis direction), respectively.

Furthermore, an area between a longitudinal cross-section of the ceramic body 110 and the thickness-directional or width-directional side surface is defined as an edge portion. That is, a curved portion between the third surface S3 or the sixth surface S6 and the first surface S1 may be referred to as a first edge portion C1, and a curved portion between the third surface S3 or the sixth surface S6 and the second surface S2 may be referred to as a second edge portion C2.

A length of the ceramic body 110 may indicate a maximum value among lengths of a plurality of line segments that connect two outermost boundary lines facing each other in the length direction (L-axis direction) of the ceramic body 110 illustrated in the cross-sectional photograph described above and are parallel to the length direction (L-axis direction) based on an optical microscope or scanning electron microscope (SEM) photograph for a cross-section of the ceramic body 110 in the length direction (L-axis direction)-thickness direction (T-axis direction) at a center in the width direction (W-axis direction). Alternatively, the length of the ceramic body 110 may indicate a minimum value among lengths of a plurality of line segments that connect two outermost boundary lines facing each other in the length direction (L-axis direction) of the ceramic body 110 illustrated in the cross-sectional photograph described above and are parallel to the length direction (L-axis direction). Alternatively, the length of the ceramic body 110 may indicate an arithmetic average value of the lengths of at least two line segments among a plurality of line segments that connect two outermost boundary lines facing each other in the length direction (L-axis direction) of the ceramic body 110 illustrated in the cross-sectional photograph described above and are parallel to the length direction (L-axis direction).

A thickness of the ceramic body 110 may indicate a maximum value among lengths of a plurality of line segments that connect two outermost boundary lines facing each other in the thickness direction (T-axis direction) of the ceramic body 110 illustrated in the cross-sectional photograph described above and are parallel to the thickness direction (T-axis direction) based on an optical microscope or scanning electron microscope (SEM) photograph for a cross-section of the ceramic body 110 in the length direction (L-axis direction)-thickness direction (T-axis direction) at a center in the width direction (W-axis direction). Alternatively, the thickness of the ceramic body 110 may indicate a minimum value among lengths of a plurality of line segments that connect two outermost boundary lines facing each other in the thickness direction (T-axis direction) of the ceramic body 110 illustrated in the cross-sectional photograph described above and are parallel to the thickness direction (T-axis direction). Alternatively, the thickness of the ceramic body 110 may indicate an arithmetic average value of the lengths of at least two line segments among a plurality of line segments that connect two outermost boundary lines facing each other in the thickness direction (T-axis direction) of the ceramic body 110 illustrated in the cross-sectional photograph described above and are parallel to the thickness direction (T-axis direction).

The width of the ceramic body 110 may indicate a maximum value among lengths of a plurality of line segments that connect two outermost boundary lines facing each other in the width direction (W-axis direction) of the ceramic body 110 illustrated in the cross-sectional photograph described above and are parallel to the width direction (W-axis direction) based on an optical microscope or scanning electron microscope (SEM) photograph for a cross-section of the ceramic body 110 in the thickness direction (T-axis direction)-width direction (W-axis direction) at a center in the width direction (W-axis direction). Alternatively, the width of the ceramic body 110 may indicate a minimum value among lengths of a plurality of line segments that connect two outermost boundary lines facing each other in the width direction (W-axis direction) of the ceramic body 110 illustrated in the cross-sectional photograph described above and are parallel to the width direction (W-axis direction). Alternatively, the width of the ceramic body 110 may indicate an arithmetic average value of lengths of at least two line segments among a plurality of line segments that connect two outermost boundary lines facing each other in the width direction (W-axis direction) of the ceramic body 110 illustrated in the cross-sectional photograph described above and are parallel to the width direction (W-axis direction).

The ceramic body 110 may include a plurality of dielectric layers 140 stacked in the thickness direction (T-axis direction). Boundaries between dielectric layers 140 may be unclear. For example, boundaries between the dielectric layers 140 are difficult to see without using a scanning electron microscope (SEM), and the dielectric layers 140 may appear as a single structure.

The first internal electrode 150 and the second internal electrode 160 may be alternately stacked with the dielectric layer 140 provided therebetween. This stacked structure may be repeated within the ceramic body 110, an internal electrode closest to the fifth side S5 of the ceramic body 110 may be the first internal electrode 150 or the second internal electrode 160, and an internal electrode closest to the sixth side S6 may be the first internal electrode 150 or the second internal electrode 160.

The first internal electrode 150 and the second internal electrode 160 may have different polarities, and may be electrically insulated from each other by the dielectric layer 140 provided therebetween.

The first internal electrode 150 and the second internal electrode 160 may be arranged to be offset from each other in the longitudinal direction (L-axis direction) with the dielectric layer 140 provided therebetween. A first end of the first internal electrode 150 may be exposed through the first surface S1 of the ceramic body 110, and a first end of the second internal electrode 160 may be exposed through the second surface S2 of the ceramic body 110. An end portion of the first internal electrode 150 exposed from the first surface S1 of the ceramic body 110 may be connected to the first external electrode 120. An end portion of the second internal electrode 160 exposed from the second surface S2 of the ceramic body 110 may be connected to the second external electrode 130.

The first internal electrode 150 and the second internal electrode 160 may be formed by printing a conductive paste including a conductive metal on a surface of the dielectric layer 140. For example, a conductive paste containing nickel (Ni) or a nickel (Ni) alloy may be printed on a surface of a dielectric material layer by screen printing or gravure printing to form an internal electrode. However, the present embodiment is not limited thereto.

For example, an average thickness of the first internal electrode 150 and the second internal electrode 160 may be approximately 0.1 μm or more and 2 μm or less.

Herein, a thickness of the internal electrode may indicate an average thickness of one internal electrode positioned between the two dielectric layers. The average thickness of the internal electrode may be the arithmetic average of the thickness of one internal electrode shown in the above-described cross-sectional photograph measured at 30 points evenly spaced in the longitudinal direction (L-axis direction), based on a scanning electron microscope (SEM) photograph at 10,000 magnification for a cross section in the longitudinal direction (L-axis direction) and thickness direction (T-axis direction) at a center portion of the ceramic body 110 in the width direction (W-axis direction). The 30 points mentioned above may be designated in an active area described below. As such, an average thickness of the internal electrodes may be more generalized by measuring the average thickness of each of 10 internal electrodes and then taking an arithmetic means of measurements.

When a voltage is applied to the first external electrode 120 and the second external electrode 130, charges are accumulated between the first internal electrode 150 and the second internal electrode 160 that are opposite to each other. That is, capacitance may be obtained between the first internal electrode 150 electrically connected to the first external electrode 120 and the second internal electrode 160 electrically connected to the second external electrode 130. The capacitance of the multilayer ceramic capacitor 100 is proportional to the overlapping area of the first internal electrode 150 and the second internal electrode 160 that overlap each other along the thickness direction (T-axis direction).

In other words, the multilayer ceramic capacitor 100 may include an active region and a margin region. The active region may refer to a region where the first internal electrode 150 and the second internal electrode 160 overlap along the thickness direction (T-axis direction), and the margin region may refer to a region between the active region and the first surface S1 of the ceramic body 110 and a region between the active region and the second surface S2 of the ceramic body 110.

The multilayer ceramic capacitor 100 may be classified based on a length and a width thereof. Accordingly, even in multilayer ceramic capacitors having the same length or width, the size of the ceramic body may vary depending on the thickness of the external electrode. That is, a multilayer ceramic capacitor with a thinner external electrode may have a larger ceramic body compared to a multilayer ceramic capacitor with a thicker external electrode. A larger ceramic body may indicate a larger active region as mentioned above, which may in turn indicate a larger electrostatic capacitance. Ultimately, as the external electrode of the multilayer ceramic capacitor become thinner, the capacitance may increase. In the present embodiment, by forming a thin electrode layer on the first and second surfaces of the ceramic body, the thickness of the external electrode may be reduced, and a beneficial effect may be obtained accordingly. This will be described in more detail below.

A first cover layer 143 and a second cover layer 145 may be arranged outside of the active region in the thickness direction (T-axis direction).

The first cover layer 143 may be disposed between the fifth surface S5 of the ceramic body 110 and the internal electrode closest thereto. The second cover layer 145 may be disposed between the sixth surface S6 of the ceramic body 110 and the internal electrode closest thereto.

That is, the first cover layer 143 having a predetermined thickness may be disposed at an uppermost portion of the internal electrode at an uppermost portion of the ceramic body 110, and the second cover layer 145 may be disposed at a lower portion of the internal electrode at a lowermost portion thereof. The first cover layer 143 and the second cover layer 145 may have a same composition as that of the dielectric layer 140. The first cover layer 143 and the second cover layer 145 may be formed by stacking one or more dielectric layers on an outer surface of the uppermost inner electrode and the outer surface of a lowermost inner electrode, respectively.

The first cover layer 143 and the second cover layer 145 may serve to prevent damage to the first internal electrode 150 and the second internal electrode 160 due to physical or chemical stress.

The dielectric layer 140 may include a ceramic material having a high permittivity. For example, the ceramic material may include a dielectric ceramic including a component such as BaTiO₃, CaTiO₃, SrTiO₃, or CaZrO₃. In addition, an auxiliary component such as a manganese (Mn) compound, an iron (Fe) compound, a chromium (Cr) compound, a cobalt (Co) compound, and a nickel (Ni) compound may be further included in these components. Examples of the dielectric layer may include (Ba₁₋ₓ Caₓ) TiO₃, Ba(Ti_{1-y} Ca_{y}) O₃, (Ba₁₋ₓ Caₓ) (Ti_{1-y} Zr_{y}) O₃, Ba(Ti_{1-y} Zr_{y}) O₃, and the like in which Ca (calcium), Zr (zirconium), etc. are partially dissolved in BaTiO₃, but the present disclosure is not limited thereto.

In addition, the dielectric layer 140 may further include at least one of a ceramic additive, an organic solvent, a plasticizer, a binder, or a dispersant. As the ceramic additive, a transition metal oxide or carbide, a rare earth element, magnesium (Mg), or aluminum (Al) may be used.

For example, an average thickness of a dielectric layer 140 may be 0.1 μm to 10 μm, but the present embodiment is not limited thereto.

The first external electrode 120 and the second external electrode 130 are positioned outside the ceramic body 110. The first external electrode 120 and the second external electrode 130 may be positioned at opposite sides of the ceramic body 110 in a first direction.

The first external electrode 120 may be positioned on the first surface S1 of the ceramic body 110, and may extend to at least one of the third surface S3, the fourth surface S4, the fifth surface S5, or the sixth surface S6. The second external electrode 130 may be positioned on the second surface S2 of the ceramic body 110, and may extend to the third surface S3, the fourth surface S4, the fifth surface S5, or the sixth surface S6.

The first external electrode 120 may include metal and glass. Herein, the metal may include a metal such as copper (Cu) or nickel (Ni), and the glass may include an oxide-based glass.

The first external electrode 120 may include a first glass portion 121 and a second glass portion 123.

The first glass portion 121 may be positioned on the first surface S1 of the ceramic body 110 and may be electrically connected to exposed end portions of the first internal electrodes 150.

The first glass portion 121 may include metal and glass. Herein, the metal may include a metal such as copper (Cu) or nickel (Ni), and the glass may include a Ba-based or Zn-based glass.

The first glass portion 121 may be formed by a semi-dry dipping method. Specifically, a paste containing a conductive metal and glass, etc., may be semi-dried, applied and dried on the first surface S1 of the ceramic body 110, and then formed by performing a heat treatment called electrode firing.

Referring to FIG. 5, it may be seen that a center of the first glass portion 121 is generally flat, and referring to FIG. 6, it may be seen that a thickness of the first external electrode 120 is secured to a certain level or more between the fifth surface S5 and the first surface S1 of the ceramic body 110 (the first edge portion (C1)).

Unlike in the present embodiment, in a case of applying a high-viscosity paste on the first surface S1 of the ceramic body 110, drying it, and then performing a heat treatment using a general dipping method, capillary bridges may be formed due to a high viscosity of the paste, and may not be leveled flatly, so even after the electrode sintering, a center of the external electrode is convex, and a corner may be thin, which may increase a thickness of the external electrode and may cause a problem of not securing a hermetic seal.

On the other hand, according to the present embodiment, by forming a first glass portion by semi-drying a paste including metal and glass, then applying, drying, and heat-treating, the thickness of the external electrode may be minimized, thereby increasing effective capacity and sufficiently securing hermetic sealing of the external electrode.

Meanwhile, the first glass portion 121, which is a portion for electrical connection with the internal electrode, may be positioned on the first surface S1 of the ceramic body 110, and may be positioned to cover exposed ends of the first internal electrodes 150 on the first surface S1 of the ceramic body 110.

The second glass portion 123 may be positioned on a portion of at least one of the third surface S3, the fourth surface S4, the fifth surface S5, or the sixth surface S6 of the ceramic body 110, and may include metal and glass. Herein, the metal may include a metal such as copper (Cu) or nickel (Ni), and the glass may include Ba-based glass, Zn-based glass, Fe-based glass, etc.

The second glass portion 123 may include Fe-based glass in addition to Ba-based and Zn-based glass as glass components, so hermetic sealing may be strengthened by imparting corrosion resistance by a plating solution, thereby ameliorating plating breakage and improving moisture resistance reliability.

The second glass portion 123 may contain 5 to 10 wt % of iron (Fe). A corrosion-resistant glass effect may be realized when the iron (Fe) component is 5 wt % or more, and when it exceeds 10 wt %, excessive sintering of the glass may cause a decrease in wettability with the metal, which may cause the glass to dissolve, resulting in plating failure and reduced moisture-resistant reliability.

The second glass portion 123 may be formed by dipping opposite sides of the ceramic body 110 on which the first glass portion 121 is formed in the first direction into a paste containing metal and glass, and blotting it onto a porous material plate (PMP) to remove the paste applied to an outer surface of the first glass portion 121. Accordingly, the second glass portion 123 may be positioned on a portion of at least one of the third surface S3, the fourth surface S4, the fifth surface S5, or the sixth surface S6 of the ceramic body 110, and may not be position on the outer surface of the first glass portion 121.

A first end of the second glass portion 123 may be in contact with the first glass portion 121, and a second end may be positioned to face the first end in the longitudinal direction (L-axis direction) of the ceramic body 110. A thickness of the second glass portion 123 may become smaller from the center to opposite ends.

The second glass portion 123 may be in contact with the first glass portion 121 between at least one of the third surface S3, the fourth surface S4, the fifth surface S5, or the sixth surface S6 of the ceramic body 110 and the first surface S1 (the first edge portion (C1)). The first glass portion 121 and the second glass portion 123 are elements that constitute the first external electrode 120 and may both be formed of metal and glass, so their boundaries may be ambiguous.

The first external electrode 120 may have a thickness T1 at a center of the first surface S1 of the ceramic body 110 and a thickness T2 between the first surface S1 and at least one of the third surface S3, the fourth surface S4, the fifth surface S5, or the sixth surface S6 of the ceramic body 110 (the first edge portion (C1)), where T2/T1 may be 0.4 to 1. Herein, the thickness T1 may refer to a thickness of the center of the first glass portion 121, and the thickness of the first glass portion 121 may be measured within a certain range based on a midpoint of the first surface S1 of the ceramic body 110, and a maximum thickness among them may be set as T1. T2 may refer to a thickness of a portion where the first glass portion 121 and the second glass portion 123 come into contact, a reference line may be set in a 45 degree direction from the first edge portion C1 of the ceramic body 110, a thickness within a certain range may be measured from this reference line, and a minimum thickness among them may be set as T2.

If a thickness ratio (T2/T1) of the first external electrode 120 is less than 0.4, a problem of low moisture resistance reliability may occur, so the thickness ratio (T2/T1) of the first external electrode 120 may be required to be 0.4 or greater. Furthermore, when forming an external electrode using a dipping method using a paste containing metal and glass, the thickness ratio (T2/T1) of the first external electrode 120 may not exceed 1 because the center of the external electrode is formed thicker than the outer portion.

The second external electrode 130 may include a third glass portion 131 and a fourth glass portion 133.

The third glass portion 131 may be positioned on the second surface S2 of the ceramic body 110 and may be electrically connected to exposed end portions of the second internal electrodes 160.

The fourth glass portion 133 may be positioned on a portion of at least one of the third surface S3, the fourth surface S4, the fifth surface S5, or the sixth surface S6 of the ceramic body 110, and may include metal and glass. The fourth glass portion 133 may include Fe-based glass as a glass component.

The second external electrode 130 may correspond to a structure, material, and function of the first external electrode 120 except for a position thereof, so a repeated description thereof will be omitted.

Meanwhile, the multilayer ceramic capacitor 100 may further include a first plating layer 180 and a second plating layer 190.

The first plating layer 180 may cover the first external electrode 120. The first plating layer 180 may include a first layer 181 and a second layer 183. The first layer 181 may be positioned on the first external electrode 120, and the second layer 183 may be positioned on the first layer 181. The first layer 181 may include nickel (Ni) and the second layer 183 may include tin (Sn), but the present embodiment is not limited thereto.

The second plating layer 190 may cover the second external electrode 130. The second plating layer 190 may include a first layer 191 and a second layer 193. The first layer 191 may be positioned on the second external electrode 130, and the second layer 193 may be positioned on the first layer 191. The first layer 191 may include nickel (Ni) and the second layer 193 may include tin (Sn), but the present embodiment is not limited thereto.

### Experimental Example 1

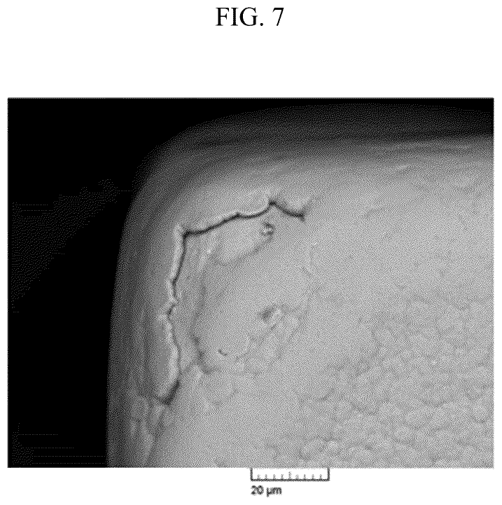

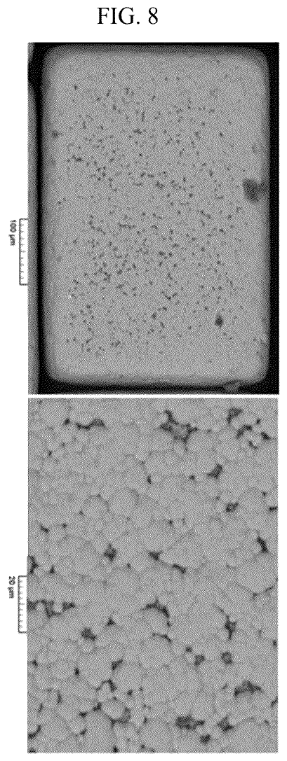

Hereinafter, plating breakage and moisture resistance reliability of Examples 1 and 2 and Comparative Examples 1 and 2 will be described with reference to FIGS. 7 and 8 and Table 1.

FIG. 7 illustrates a digital image showing a portion of a multilayer ceramic capacitor according to Comparative example 1, and

FIG. 8 illustrates a digital image showing a portion of a multilayer ceramic capacitor according to Comparative Example 2, and Table 1 is a table showing capacitance contact, plating breakage, and moisture resistance reliability of Examples 1 and 2 and Comparative Examples 1 and 2.

TABLE 1

| | | | | Moisture |
|---|---|---|---|---|
| | | Head surface | Triple point | resistance |
| | Capacity | plating | Plating | degradation |
| Division | contact | breakage | breakage | ppm |
| Example | OK | 0% | 0% | 0 |
| Comparative | OK | 0% | 30% | 13333 |
| Example 1 | | | | |
| Comparative | X | 60% | 0% | 18333 |
| Example 2 | | | | |

In Table 1, the examples are related to multilayer ceramic capacitors in which external electrodes positioned outside a ceramic body have the structures shown in FIGS. 1 to 4.

Comparative Example 1 is related to a multilayer ceramic capacitor in which all external electrodes are formed with a conventional conductive paste, and Comparative Example 2 is related to a multilayer ceramic capacitor in which all external electrodes are formed with a corrosion-resistant paste that further contains iron (Fe).

Referring to Table 1, in the case of Comparative Example 1, capacity contact was good and head surface plating breakage was 0%, but triple point plating breakage was 30% and a moisture deterioration characteristic was high at 13333 ppm. Herein, the capacitive contact may represent the electrical connectivity between the inner electrode and the outer electrode, the head surface may represent the first or second surface of the ceramic body, and a triple point may represent a point where two adjacent surfaces among the first or second surface and the third to sixth surfaces of the ceramic body meet. Referring to FIG. 7, it may be seen that in the case of Comparative Example 1, plating breakage occurs at the triple point. Herein, plating breakage may be measured by removing Sn using a Sn stripping solution etchant on an external electrode on which a Ni—Sn plating layer has been formed, and then observing with a scanning electron microscope (SEM) whether there is any Ni plating breakage.

In the case of Comparative Example 2, the triple plating breakage was 0%, but the capacity contact was poor, the head surface plating breakage was 60%, and the moisture resistance degradation characteristic was high at 18333 ppm. Referring to FIG. 8, it may be seen that in the case of Comparative Example 2, plating breakage occurs at the head surface. Accordingly, it may be seen that applying anti-corrosion paste to the head surface results in poor capacitive contact and significantly reduced moisture resistance reliability.

On the other hand, in the case of an example in which a glass portion including metal and glass is positioned on a longitudinal cross-section of the ceramic body as an external electrode, and a glass portion further including iron (Fe) is positioned on a thickness directional or width directional side surface of the ceramic body, the capacitive contact was good, the head plating breakage was 0%, the triple point plating breakage was 0%, and the moisture resistance degradation characteristic was at 0 ppm. Accordingly, it may be confirmed that the capacity contact and the moisture resistance reliability are significantly improved compared to Comparative Examples 1 and 2.

### Experimental Example 2

Hereinafter, the moisture resistance reliability and other defects according to an iron (Fe) content of the glass portion (hereinafter referred to as “second and fourth glass portions”) positioned on the thickness directional or width directional side surface of the ceramic body among the external electrodes for various samples will be described.

Table 2 shows characteristics, such as moisture resistance reliability, of samples with different iron (Fe) contents in the second and fourth glass portions of the external electrode.

TABLE 2

| | | | Moisture | |
|---|---|---|---|---|
| | | Plating solution | resistance | |
| | Fe content | penetration | reliability | |
| Division | (wt %) | frequency (%) | Defect (ppm) | Other defects |
| Sample 1 | 0 | 55 | 18333 | Ni plating |
| | | | | layer triple |
| | | | | point corner |
| | | | | breakage |
| Sample 2 | 3 | 2 | 13333 | Ni plating |
| | | | | layer triple |
| | | | | point corner |
| | | | | breakage |
| Sample 3 | 5 | 0 | 0 | No defects |
| Sample 4 | 7 | 0 | 0 | No defects |
| Sample 5 | 10 | 0 | 0 | No defects |
| Sample 6 | 11 | 0 | 1666 | Plating breakage |
| | | | | due to Glass |
| | | | | elute NG |
| Sample 7 | 13 | 0 | 2500 | Plating breakage |
| | | | | due to Glass |
| | | | | elute NG |

In Table 2, Samples 1, 2, 6, and 7 are related to multilayer ceramic capacitors according to comparative examples, and samples 3 to 5 are related to multilayer ceramic capacitors according to examples.

Referring to Table 2, as comparative examples, in a case of Samples 1 and 2 in which an iron (Fe) content of the second and fourth glass portions was less than 5 wt %, the plating solution penetration frequency was 55% and 2%, respectively, and the moisture resistance reliability was 18,333 ppm and 13,333 ppm, respectively, which were found to be defective, and both samples were found to be defective due to edges of the triple point of the Ni plating layer being broken. Accordingly, it may be confirmed that the corrosion resistance effect is not expressed when the iron (Fe) content is less than 5 wt %.

As comparative examples, in the case of Samples 6 and 7 in which the iron (Fe) content of the second and fourth glass portions exceeded 10 wt %, the plating solution penetration frequency was 0% in both cases, but the moisture resistance reliability was poor at 1666 ppm and 2500 ppm, respectively, and both samples were found to be poor due to plating interruption caused by glass dissolution. Accordingly, it may be confirmed that when the iron (Fe) content exceeds 10 wt %, glass dissolution occurs due to reduced wettability with metal caused by excessive sintering of the glass, which causes plating breakage and reduces moisture resistance reliability.

On the other hand, in the case of Samples 2, 3, and 4 in which the iron (Fe) content of the second and fourth glass portions was 5 to 10 wt % as examples, the plating solution penetration frequency was all 0%, the moisture resistance reliability defects were all 0 ppm, and no other defects were observed. Accordingly, it can be seen that the iron (Fe) content of the second and fourth glass portions of the external electrode is preferably 5 to 10 wt %.

### Experimental Example 3

Hereinafter, the moisture resistance reliability according to a ratio of a central thickness T1 and an edge thickness T2 of the external electrode for various samples will be described with reference to Table 3.

Table 3 shows the moisture resistance reliability according to a thickness ratio of central and edge portions of the external electrodes of various samples in a 0603 type of multilayer ceramic capacitors.

TABLE 3

| | | | Thickness | Moisture | |
|---|---|---|---|---|---|
| | External electrode | | ratio | resistance | Poor |
| | thickness (μm) | | (T2/T1) | reliability | deter- |
| Division | Center T1 | Edge T2 | (%) | Defect (ppm) | mination |
| Sample 1 | 20 | 0.9 | 0.05 | 15833 | NG |
| Sample 2 | 15 | 1.5 | 0.1 | 7500 | NG |
| Sample 3 | 10 | 3.6 | 0.36 | 833 | NG |
| Sample 4 | 10 | 4.2 | 0.42 | 0 | OK |
| Sample 5 | 9 | 3 | 0.33 | 833 | NG |
| Sample 6 | 9 | 4.1 | 0.46 | 0 | OK |
| Sample 7 | 8 | 4.2 | 0.53 | 0 | OK |

In Table 3, Sample 1 is a sample in which an external electrode is formed by a conventional dipping method, Sample 2 is a sample in which an external electrode sheet transition (EEST) method of transferring a dry sheet to a ceramic body is applied, and Samples 3 to 7 are samples in which a semi-dry dipping method is applied, but thicknesses of the center and edge portions of the external electrode are different.

Referring to Table 3, in the case of Sample 1 by the conventional dipping method and Sample 2 by the EEST method, the thickness ratios (T2/T1) of the center and edge of the external electrodes were 0.05 and 0.1, respectively, indicating that the edge was relatively thin, and as a result, the moisture resistance reliability defects were also very high at 15,833 ppm and 7,500 ppm, respectively, indicating defects.

For Samples 3 and 4 prepared by the semi-dry dipping method, the central thickness T1 of the external electrode was the same at 10 μm, the edge thicknesses T2 were 3.6 μm and 4.2 μm, respectively, and the thickness ratios (T2/T1) of the external electrode were 0.36 and 0.42, respectively. Herein, for Sample 4, where the thickness ratio (T2/T1) of the external electrode was 0.4 or more, the moisture resistance reliability defect was 0 and was determined as good, but for Sample 3, where the thickness ratio (T2/T1) of the external electrode was less than 0.4, the moisture resistance reliability defect was 833 ppm and was determined as bad.

For Samples 5 and 6 prepared by the semi-dry dipping method, the central thickness T1 of the external electrode was the same at 9 μm, the edge thickness T2 were 3 μm and 4.1 μm, respectively, and the thickness ratios (T2/T1) of the external electrode were 0.33 and 0.46, respectively. Herein, for Sample 6, where the thickness ratio (T2/T1) of the external electrode was 0.4 or more, the moisture resistance reliability defect was 0 and was determined as good, but for Sample 5, where the thickness ratio (T2/T1) of the external electrode was less than 0.4, the moisture resistance reliability defect was 833 ppm and was determined as bad.

In the case of sample 7 prepared by the semi-drying dipping method, the central thickness T1 of the external electrode was 8 μm, the edge thickness T2 was 4.2 μm, and the thickness ratio (T2/T1) of the external electrode was 0.53, which was the highest among the samples in this Experimental Example. Sample 7 was determined to be a good product because the thickness ratio (T2/T1) of the external electrode was 0.4 or more, the moisture resistance reliability was 0, and it was determined to be a good product.

As such, it may be seen that the thickness ratio (T2/T1) of the external electrode is higher in the case of the semi-dry dipping method compared to the conventional method, and it may be seen that the thickness ratio (T2/T1) of the external electrode must be 0.4 or more to avoid poor moisture resistance reliability. In the present experimental example, Samples 4, 6, and 7 determined to be good products had a thickness ratio (T2/T1) of the external electrode of 0.4 or more and 0.6 or less.

### Experimental Example 4

Hereinafter, the moisture resistance reliability according to a ratio of a central thickness T1 and an edge thickness T2 of the external electrode for various samples will be described with reference to Table 4.

Table 4 shows the moisture resistance reliability according to a thickness ratio of central and edge portions of the external electrodes of various samples in a 1005 type of multilayer ceramic capacitors.

TABLE 4

| | | | Thickness | Moisture | |
|---|---|---|---|---|---|
| | External electrode | | ratio | resistance | Poor |
| | thickness (μm) | | (T2/T1) | reliability | deter- |
| Division | Center T1 | Edge T2 | (%) | Defect (ppm) | mination |
| Sample 1 | 28 | 2.2 | 0.079 | 1667 | NG |
| Sample 2 | 20 | 2.5 | 0.125 | 1667 | NG |
| Sample 3 | 15 | 5.5 | 0.367 | 833 | NG |
| Sample 4 | 13 | 5.4 | 0.415 | 0 | OK |
| Sample 5 | 12 | 4.9 | 0.408 | 0 | OK |
| Sample 6 | 11 | 3.1 | 0.258 | 833 | NG |
| Sample 7 | 10 | 4.2 | 0.420 | 0 | OK |

In Table 4, Sample 1 is a sample in which an external electrode is formed by a conventional dipping method, Sample 2 is a sample in which an external electrode sheet transition (EEST) method of transferring a dry sheet to a ceramic body is applied, and Samples 3 to 7 are samples in which a semi-dry dipping method is applied, but thicknesses of the center and edge portions of the external electrode are different.

Referring to Table 4, in the case of Sample 1 by the conventional dipping method and Sample 2 by the EEST method, the thickness ratios (T2/T1) of the center and edge of the external electrodes were 0.079 and 0.125, respectively, indicating that the edge was relatively thin, and as a result, the moisture resistance reliability defects were also very high at 1,667 ppm in both cases, indicating defects.

For Samples 3 to 7 formed by the semi-dry dipping method, the thickness T1 of the center of the external electrode was formed to be thinner by 1 μm from 15 μm. Samples 3 and 6 showed external electrode thickness ratios T2/T1 of 0.367 and 0.258, respectively, which were less than 0.4, and these samples were determined to have poor moisture resistance reliability of 833 ppm.

Meanwhile, Samples 4, 5, and 7 showed external electrode thickness ratios (T2/T1) of 0.415, 0.408, and 0.42, respectively, which were all above 0.4, and these samples were determined to be good products with a moisture resistance reliability of 0.

As such, it may be seen that the thickness ratio (T2/T1) of the external electrode is higher in the case of the semi-dry dipping method compared to the conventional method, and it may be seen that the thickness ratio (T2/T1) of the external electrode must be 0.4 or more to avoid poor moisture resistance reliability. In the present experimental example, Samples 4, 6, and 7 determined to be good products had a thickness ratio (T2/T1) of the external electrode of 0.4 or more and 0.6 or less.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor comprising:
a ceramic body including a plurality of dielectric layers and internal electrodes arranged with the dielectric layers provided therebetween; and
external electrodes arranged at opposite sides of the ceramic body in a first direction, respectively,
wherein the external electrodes include, respectively:
a first glass portion positioned on a first directional end surface of the ceramic body and connected to the internal electrodes; and
a second glass portion positioned on at least a portion of at least one of second and third directional side surfaces of the ceramic body and containing an iron (Fe) component.

2. The multilayer ceramic capacitor of claim 1, wherein
the second glass portion contains 5 to 10 wt % of the iron (Fe) component.

3. The multilayer ceramic capacitor of claim 1, wherein
for the external electrodes,
T2/T1 is within 0.4 and 1, in which T1 is a thickness of the external electrodes in a central portion of the first directional end surface of the ceramic body and T2 is a thickness of the external electrodes disposed at an edge between the first directional end surface and the at least one of second and third directional side surfaces of the ceramic body.

4. The multilayer ceramic capacitor of claim 3, wherein
T2/T1 is 0.4 to 0.6.

5. The multilayer ceramic capacitor of claim 1, wherein
the first glass portion includes a metal including copper (Cu) or nickel (Ni) and Ba-based or Zn-based glass.

6. The multilayer ceramic capacitor of claim 1, wherein
the second glass portion includes a metal including copper (Cu) or nickel (Ni) and Ba-based or Zn-based glass.

7. The multilayer ceramic capacitor of claim 1, wherein
the external electrodes further include a plating layer covering the first glass portion and the second glass portion.

8. A multilayer ceramic capacitor comprising:
a ceramic body including a plurality of dielectric layers and internal electrodes arranged with the dielectric layers provided therebetween;
external electrodes arranged at opposite sides of the ceramic body in a first direction, respectively,
wherein the external electrodes include a metal component and a glass component, and
a portion of the external electrodes, positioned on at least one of second and third directional side surfaces of the ceramic body, further contain an iron (Fe) component.

9. The multilayer ceramic capacitor of claim 8, wherein
the external electrodes include 5 to 10 wt % of the iron (Fe) component.

10. The multilayer ceramic capacitor of claim 8, wherein
for the external electrodes,
T2/T1 is within 0.4 and 1, in which T1 is a thickness of the external electrodes in a central portion of the first directional end surface of the ceramic body and T2 is a thickness of the external electrodes disposed at an edge between the first directional end surface and the at least one of second and third directional side surfaces of the ceramic body.

11. The multilayer ceramic capacitor of claim 10, wherein
T2/T1 is 0.4 to 0.6.

12. The multilayer ceramic capacitor of claim 8, wherein
the metal component includes copper (Cu) or nickel (Ni).

13. The multilayer ceramic capacitor of claim 8, wherein
the glass component includes Ba-based or Zn-based glass.

14. A multilayer ceramic capacitor comprising:
a ceramic body including a plurality of dielectric layers and first and second internal electrodes arranged with the dielectric layers provided therebetween; and
first and second external electrodes arranged at opposite sides of the ceramic body in a first direction, respectively,
wherein the first external electrode includes:
a first glass portion positioned on a first directional end surface of the ceramic body and connected to the first internal electrodes; and
a second glass portion positioned on at least a portion of at least one of second and third directional side surfaces of the ceramic body and having a content of iron (Fe) greater than a content of Iron (Fe) in the first glass portion.

15. The multilayer ceramic capacitor of claim 14, wherein
the second glass portion contains 5 to 10 wt % of the iron (Fe).

16. The multilayer ceramic capacitor of claim 14, wherein
for the first external electrode,
T2/T1 is within 0.4 and 1, in which T1 is a thickness of the first external electrode in a central portion of the first directional end surface of the ceramic body and T2 is a thickness of the first external electrode disposed at an edge between the first directional end surface and the at least one of second and third directional side surfaces of the ceramic body.

17. The multilayer ceramic capacitor of claim 16, wherein
T2/T1 is 0.4 to 0.6.

18. The multilayer ceramic capacitor of claim 14, wherein
the first glass portion includes a metal including copper (Cu) or nickel (Ni) and Ba-based or Zn-based glass.

19. The multilayer ceramic capacitor of claim 14, wherein
the second glass portion includes a metal including copper (Cu) or nickel (Ni) and Ba-based or Zn-based glass.

20. The multilayer ceramic capacitor of claim 14, wherein
a content of Iron (Fe) in the first external electrode decreases in an edge between the first directional end surface and the at least one of second and third directional side surfaces of the ceramic body, along a path from the second glass portion to the first glass portion.
